(19) United States
(12) Patent Application Publication
(10) Pub. No.: US 2026/0274549 A1
(43) Pub. Date: Sep. 17, 2026

(54) COMPOSTABLE SLEEVE APPARATUS AND METHOD OF MANUFACTURE

(71) Applicants: Klara Tess Grant, Pleasanton, CA (US); Irma Wilhelmina Grant, Pleasanton, CA (US); Aydin Mehrage, Pleasanton, CA (US)

(72) Inventors: Klara Tess Grant, Pleasanton, CA (US); Irma Wilhelmina Grant, Pleasanton, CA (US); Aydin Mehrage, Pleasanton, CA (US)

(21) Appl. No.: 19/079,593

(22) Filed: Mar. 14, 2025

(51) Int. Cl. B65D 81/38; B65D 65/46; D21B 1/02; D21F 11/10; D21F 13/10; D21H 11/12

(52) U.S. Cl. CPC B65D 81/3876; B65D 65/466; D21F 11/10; D21H 11/12; D21B 1/023; D21F 13/10

(57) ABSTRACT

A compostable sleeve apparatus for beverage containers addresses environmental concerns in packaging technology by utilizing biodegradable materials, such as corn husks, to form an insulating sleeve. This design reduces reliance on non-biodegradable materials and minimizes ecological impact. The sleeve comprises a body formed from a molded biodegradable pulp mixture, featuring an inner surface configured to receive a beverage container and an outer surface providing thermal insulation. The manufacturing process involves washing, processing, and soaking the raw biodegradable material, adjusting pH with soda ash, boiling, mashing into pulp, and forming the sleeve using a mold. The sleeve is then compressed, dried, and secured with biodegradable adhesive. This apparatus offers an eco-friendly alternative to traditional packaging, supporting sustainable waste management practices. The primary use is to insulate beverage containers while being compostable, thus reducing landfill waste and promoting environmental sustainability.

### BACKGROUND OF THE INVENTION

### Field of Endeavor

The present disclosure relates to the field of packaging technology, specifically to beverage container sleeves made from compostable materials.

### Background of Related Art

Millions of trees are cut down each year to create disposable coffee cup sleeves made from cardboard requiring relatively thick material to achieve desired levels of insulation. Additionally, the cardboard making process produces harmful environmental effects, e.g., harmful air and fluid discharges from pulp mills. At the same time, tens of millions of tons of corn husks are discarded each year and thus go unused.

Conventional coffee cup sleeves suffer from (1) destruction of forests to create cardboard, (2) harmful environmental effects of the cardboard making process, (3) harmful environmental effects of synthetic glue making process, and (4) large thickness to achieve a wanted level of insulation. These sleeves provide a sufficient level of insulation, but at the cost of a thicker material, thus requiring large space and energy required for storage and transport.

In the field of packaging, there is an increasing demand for solutions that are environmentally friendly. Traditional packaging materials often consist of non-biodegradable substances, which contribute to environmental pollution and pose challenges for waste management. As sustainability becomes a priority for both consumers and regulatory bodies, the need for packaging solutions that reduce environmental impact is becoming more pressing.

Many current market solutions do not adequately address these environmental concerns. A significant number of existing packaging materials are not compostable, leading to increased landfill waste and a larger carbon footprint. Furthermore, the production processes for these materials can be resource-intensive, exacerbating their environmental impact.

As can be seen, there is a need for innovative approaches that provide more sustainable alternatives, aligning with global efforts to reduce waste and promote eco-friendly practices.

### SUMMARY OF THE INVENTION

In one embodiment, the disclosure includes an insulating sleeve comprising a body formed from a molded biodegradable pulp mixture, having an inner surface configured to receive a beverage container, an outer surface disposed opposite the inner surface, and a thickness sufficient to provide thermal insulation to the beverage container. In embodiments, the molded biodegradable pulp mixture includes processed corn husks.

In a further embodiment, the disclosure includes a method for manufacturing a compostable sleeve apparatus for insulating a beverage container, comprising washing and processing a raw biodegradable material; soaking the raw biodegradable material for a first predetermined time to form a mixture; adding soda ash to the mixture to adjust a pH value to a range of approximately 10.0 to 11.0; boiling the mixture for a second predetermined time; draining the mixture and rinsing the raw biodegradable material until a desired pH in the range of approximately 7.0 to 8.0 is achieved; mashing the rinsed raw biodegradable material to form a pulp and blending the pulp with water to form a uniform pulp mixture; submerging a mold element in the uniform pulp mixture and subsequently lifting the mold elements to deposit a layer of the uniform pulp mixture thereon; removing from the mold element the layer of uniform pulp mixture; applying a compressive force to the layer of uniform pulp mixture, thereby removing excess water and forming the layer of uniform pulp mixture into the compostable sleeve apparatus; drying the compostable sleeve apparatus for a second predetermined time, thereby hardening the compostable sleeve apparatus; and applying an adhesive to a first surface of the compostable sleeve apparatus and securing the first surface to a second surface of the compostable sleeve apparatus. In embodiments, the raw biodegradable material comprises corn husks. In embodiments, the mold element includes a first mold having a screen thereon disposed over a second mold.

These and other features will be more clearly understood from the following detailed description taken in conjunction with the accompanying drawings and claims.

### BRIEF DESCRIPTION OF THE DRAWINGS

FIG. 1 illustrates a schematic diagram of the interaction between a user and biodegradable material in the context of a Compostable Sleeve Apparatus;

FIG. 2 is a schematic diagram illustrating the components involved in the formation of the Compostable Sleeve Apparatus;

FIG. 3 is a schematic diagram illustrating the Compostable Sleeve Apparatus formed from molded biodegradable material;

FIG. 4 is a schematic diagram illustrating the layered structure of the Compostable Sleeve Apparatus;

FIG. 5 illustrates a schematic of the Compostable Sleeve Apparatus in the process of being assembled;

FIG. 6 is a schematic diagram illustrating the Compostable Sleeve Apparatus formed from molded biodegradable material;

FIG. 7 is a schematic diagram illustrating the Compostable Sleeve Apparatus enclosing a cup; and

FIG. 8 is a flow chart diagram illustrating the method for manufacturing a Compostable Sleeve Apparatus.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

In the realm of packaging technology, particularly concerning beverage container sleeves, there exists a significant challenge in addressing environmental sustainability. Traditional beverage container sleeves are predominantly manufactured from non-biodegradable materials, which contribute substantially to environmental pollution. These materials, often derived from plastics or other synthetic substances, do not decompose naturally, leading to increased landfill waste and a larger carbon footprint. As global awareness of environmental issues grows, there is a pressing need for packaging solutions that minimize ecological impact and align with sustainable practices.

The disadvantages of existing technology in this field are numerous. Many current beverage container sleeves are not designed with compostability in mind, resulting in products that persist in the environment long after their intended use. The production processes for these materials often require substantial resources, consuming large amounts of energy and raw materials, which further exacerbate their environmental impact. Additionally, the disposal of such non-compostable sleeves poses challenges for waste management systems, as they are not easily recyclable and often end up in landfills or as litter.

In response to these challenges, the present development offers an innovative solution in the form of a compostable beverage container sleeve. This creation is designed to address the environmental concerns associated with traditional packaging by utilizing materials that are capable of decomposing under composting conditions. The compostable sleeve is engineered to enclose a beverage container securely while being environmentally friendly. The sleeve features an inner surface configured to receive the beverage container and an outer surface that defines a peripheral boundary, with an opening to facilitate easy insertion and removal of the container. This development not only reduces the ecological footprint of beverage packaging but also supports global efforts towards sustainable waste management practices.

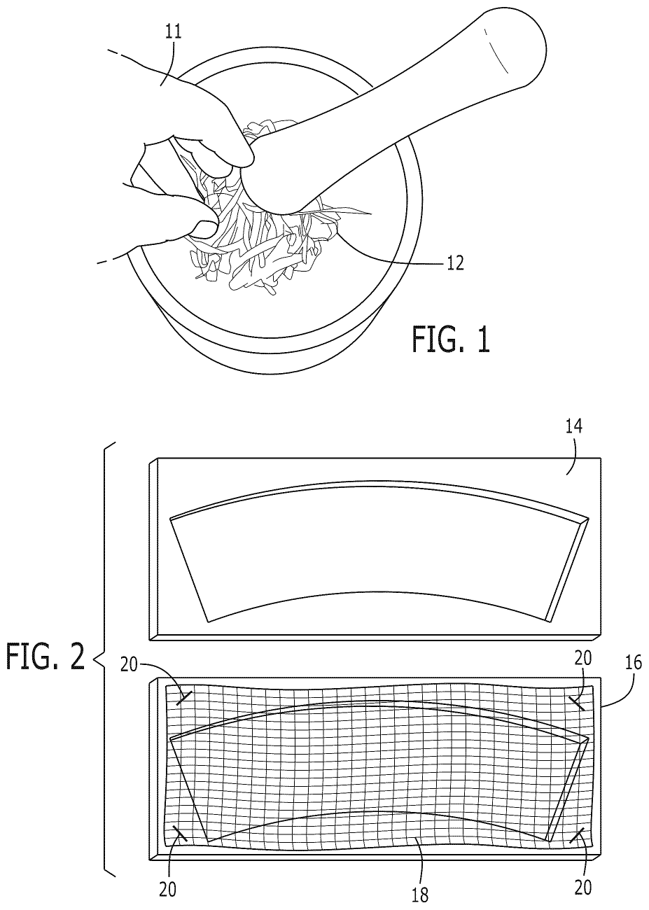

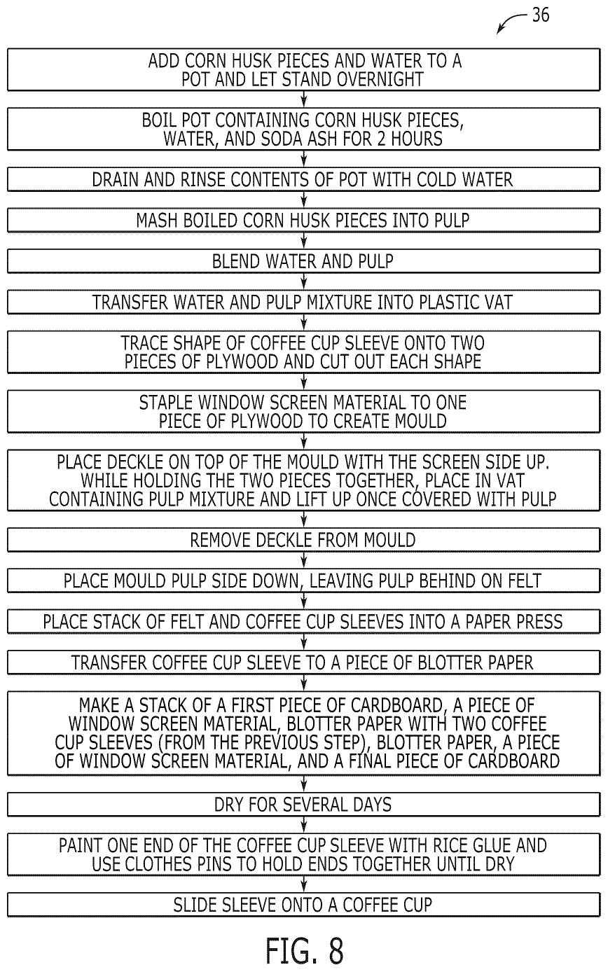

Referring now to FIGS. 1-7, the figures illustrate aspects of construction of a compostable sleeve apparatus 10, and are described with reference to a method 36 of making the compostable sleeve apparatus 10. FIG. 8 shows a method 36 for manufacturing a compostable sleeve apparatus 10, which is designed to enclose a beverage container. This method involves several steps that transform raw materials into a finished product, emphasizing the use of molded biodegradable material 22 to address environmental concerns associated with traditional packaging.

Prior to performing method 36, one or more preparation steps can be performed. In embodiments, one or more raw biodegradable materials, such as corn husks 12 are washed and processed, in preparation for use in method 36. In an embodiment, processing can include cutting, or otherwise sizing, corn husks 12 into an appropriate size for further use, such as 1 inch by 1 inch squares.

Once washed and processed an amount of corn husks 12 can be added into a vessel along with an amount of water, which can be left to sit, or soak, for a time period. In an embodiment, the amount of corn husks 12 can be 0.5 pounds, the amount of water can be 1 gallon, and the time period can be between 8 and 12 hours. Advantageously, soaking corn husks 12 allows them to become soft, making for easier processing.

Additionally, Soda Ash can be prepared for use in the creation of compostable apparatus 10. Soda Ash can be prepared by adding an amount of baking soda to a container and heating over medium heat, while stirring, until all moisture has evaporated. Once all moisture has evaporated, the remaining material is Soda Ash. In embodiments, 3 tablespoons of Soda Ash is added to the vessel containing corn husks 12, and a pH of the mixture is tested. In embodiments, if the pH is found to be below 10.0 an additional 0.5 tablespoons of Soda Ash should be added to the vessel and the pH retested. In embodiments, the process of adding 0.5 tablespoons of Soda Ash and pH re-testing should be repeated until the resulting mixture has a pH in the range of 10.0-11.0.

Once the pH of the vessel is in the appropriate range, i.e. 10.0-11.0, the vessel and its contents, i.e. corn husks 12, should be boiled for a time period. In embodiments, the time period is approximately 2 hours. Advantageously, the boiling process helps to break down corn husks 12 further, facilitating the creation of a pulp. Once boiling is completed, the contents of the vessel, i.e. corn husks 12, are drained and rinsed with water, preferably cold water. In embodiments, the pH of the contents of the vessel should be periodically tested and rinsing should continue until a desired pH range, such as 7.0-8.0, is reached. Once the desired pH range any residual water in corn husks 12 should be removed, resulting in corn husks 12 being ready for processing as per method 36.

In embodiments, boiled corn husk 12 are then mashed into a pulp, by user 11, which is subsequently blended with water to achieve a uniform consistency (as illustrated in FIG. 1). In embodiments, a mallet can be used to mash corn husks 12 into the pulp, but the tool is not so limited, as any mashing tool known in the art can be used. This water and pulp mixture 22 is transferred into a plastic vat, where the pulp mixture 22 will be used to form the compostable sleeve apparatus 10.

The method continues with the preparation of a mold(s). The shape of a coffee cup sleeve is traced onto two pieces of plywood, which are then cut out. A piece of window screen material 18 is stapled to one of the plywood pieces to create the mold (as illustrated in FIG. 2). The second plywood piece does not have any material stapled to it and is a deckle 14. The deckle 14, as illustrated in FIG. 2, is placed on top of the mold with the screen side up, and the two pieces are held together while being submerged in the vat containing the pulp mixture 22. Once the mold is covered with pulp mixture 22, the mold is lifted out of the vat.

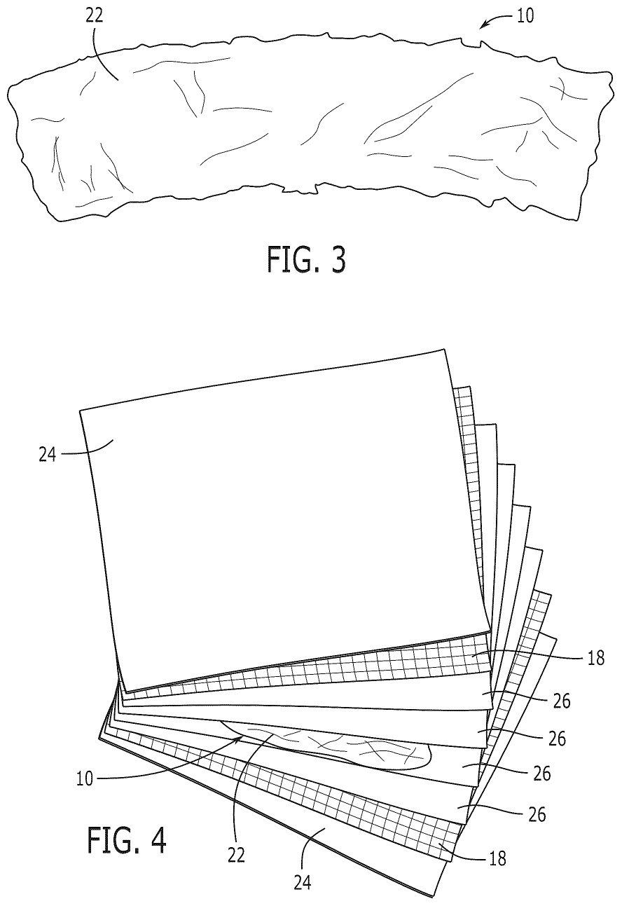

The deckle 14 is removed from the mold 16, and the mold 16 is placed upside down, leaving the pulp mixture 22 behind on a piece of felt. This step plays a significant role in shaping the pulp mixture 22 into compostable sleeve apparatus 10 (as illustrated in FIG. 3). The felt and compostable sleeve apparatus 10 are then placed into a paper press to remove excess water and solidify the structure.

The compostable sleeve apparatus 10 is transferred to a piece of blotter paper 26, and a stack consisting of a first piece of cardboard 24, a piece of screen 18 material, blotter paper 16 with compostable sleeve apparatuses 10, another piece of blotter paper 26, a second piece of screen 18 material, and a final piece of cardboard 24, is made (as illustrated in FIG. 4). The stack is placed into a paper press, where it is compressed for such that all moisture is removed from the compostable sleeve apparatus 10. In alternative embodiments, one or more weighted items can be substituted for the paper press, requiring only that they provide compressive force to the stack to remove moisture. The stack is left to dry for a time period, allowing compostable sleeve apparatuses 10 to harden and take on their final form. In embodiments, the time period can range be approximately 2 days.

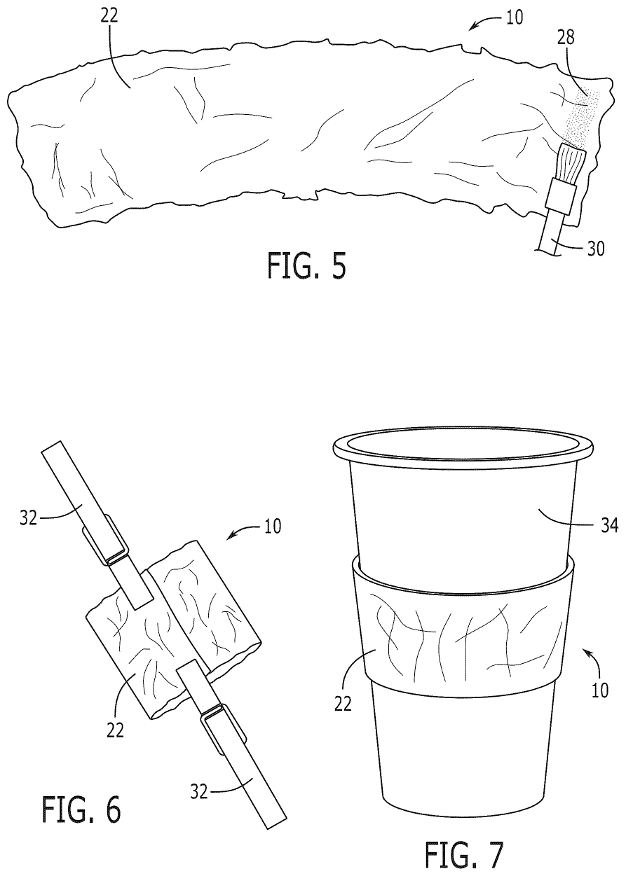

Once dry, one end of the compostable sleeve apparatus 10 is painted with glue 28 (as illustrated in FIG. 5), and clothes pin 32 are used to hold the ends together until the glue dries (as illustrated in FIG. 6). In embodiments, glue 28 is rice glue which can be provided, or made, as described hereinafter. This step ensures that compostable sleeve apparatus 10 maintains its shape and can securely enclose a coffee cup 34. At this point, compostable sleeve apparatus 10 is ready to be placed onto coffee cup 34 (as illustrated in FIG. 7), completing the manufacturing process.

In embodiments, the result of method 36 is one or more Compostable sleeve apparatus(es) 10, formed of compostable materials, such as corn husks 12. In embodiments, compostable sleeve apparatus 10 can, by virtue of its construction, have insulating qualities that prevent, or mitigate, the transfer of heat/cold to user 11 holding a contained, such as coffee cup 34, with compostable sleeve apparatus 10 thereon. In embodiments, one or more of the material, and/or thickness, of compostable sleeve apparatus 10 provide insulating capabilities. Compostable sleeve apparatus 10 can be formed as a singular, monolithic body, having a plurality of surfaces, such as an inner surface, an outer surface, and one or more additional surface, such as a first side surface disposed between and connecting the inner surface and the outer surface, and a second side surface, different from the first side surface, disposed between and connecting the inner surface and the outer surface. Additionally, as outlined in method 36, compostable sleeve apparatus 10 can be formed by affixing a first end of the body to a second end of a body thereby forming sleeve, sheath, tubular, or similar shape.

The use of a molded biodegradable pulp mixture, particularly incorporating materials such as processed corn husks, offers a sustainable alternative to traditional non-biodegradable materials like plastic or thick cardboard. This composition not only reduces environmental impact by utilizing renewable resources but also addresses the issue of waste management, as the sleeve is designed to decompose under composting conditions. The physical arrangement of the inner and outer surfaces, along with the specified thickness, ensures effective thermal insulation, maintaining the temperature of the beverage while protecting the user's hand from heat. This design provides a practical application by offering an eco-friendly solution that meets the functional requirements of a beverage container sleeve, thereby aligning with global efforts to reduce reliance on non-renewable resources and minimize ecological footprints.

In embodiments, glue 28 is rice glue which is biodegradable, and can be made, or purchased. In embodiments, to make rice glue a user can cook an amount of white rice and let cool. In embodiments, the amount of white rice cooked can be 1 cup, but is not so limited. Once cooled, the white rice and a tablespoon of water can be blended using known blending techniques in the art, such as a kitchen blender. During blending water is continuously added until a desired consistency is reached. In embodiments, the desired consistency is a semi-viscous glue-like consistency.

It should be understood, of course, that the foregoing relates to exemplary embodiments of the invention and that modifications may be made without departing from the spirit and scope of the invention as set forth in the following claims.

1. (canceled)

2. (canceled)

3. A method for manufacturing a compostable sleeve apparatus for insulating a beverage container, comprising:
(a) washing and processing a raw biodegradable material;
(b) soaking the raw biodegradable material for a first predetermined time to form a mixture;
(c) adding soda ash to the mixture to adjust a pH value to a range of approximately 10.0 to 11.0;
(d) boiling the mixture for a second predetermined time;
(e) draining the mixture and rinsing the raw biodegradable material until a desired pH in the range of approximately 7.0 to 8.0 is achieved;
(f) mashing the rinsed raw biodegradable material to form a pulp and blending the pulp with water to form a uniform pulp mixture;
(g) submerging a mold element in the uniform pulp mixture and subsequently lifting the mold elements to deposit a layer of the uniform pulp mixture thereon;
(h) removing from the mold element the layer of uniform pulp mixture;
(i) applying a compressive force to the layer of uniform pulp mixture, thereby removing excess water and forming the layer of uniform pulp mixture into the compostable sleeve apparatus;
(j) drying the compostable sleeve apparatus for a second predetermined time, thereby hardening the compostable sleeve apparatus; and
(k) applying an adhesive to a first surface of the compostable sleeve apparatus and securing the first surface to a second surface of the compostable sleeve apparatus.

4. The method of claim 3, wherein the raw biodegradable material comprises corn husks.

5. The method of claim 3, wherein the mold element includes a first mold having a screen thereon disposed over a second mold.

6. The method of claim 3, wherein the adhesive comprises at least rice.
